(19) United States
(12) Patent Application Publication
(10) Pub. No.: US 2014/0092729 A1
(43) Pub. Date: Apr. 3, 2014

(54) Data Transmission in a Packet Transport Network (PTN)

(71) Applicant: Hangzhou H3C Technologies Co., Ltd., Hangzhou (CN)

(72) Inventors: Jianyuan Peng, Beijing (CN); Guoliang Zheng, Beijing (CN)

(73) Assignee: Hangzhou H3C Technologies Co., Ltd., Hangzhou (CN)

(21) Appl. No.: 13/974,037

(22) Filed: Aug. 22, 2013

(30) Foreign Application Priority Data
Sep. 28, 2012 (CN) 201210368607.6

(51) Int. Cl. H04L 12/781

(52) U.S. Cl. CPC H04L 45/52
USPC 370/228; 370/389

(57) ABSTRACT

The present disclosure describes data transmission in a packet transport network (PTN). A multiple stack device facilitates data transmission between a first edge device of a first PTN technology and a second edge device of a second PTN technology. After receiving a first packet of the first PTN technology from the first edge device, the multiple stack device identifies a first connection with the first edge device according to information of the first packet and identifies a second connection with the second edge device from the first connection based on a relationship between the first connection and the second connection. The first packet is de-encapsulated and re-encapsulated into a second packet of the second PTN technology according to the second connection. The second packet is then forwarded to the second edge device via the second connection.

### BACKGROUND

The accelerating growth of packet-based services has brought new demands and challenges to transport networks. Example packet-based services include Ethernet, Voice over Internet Protocol (VOIP), Virtual private network (VPN), Internet Protocol Television (IPTV) and mobile backhaul transport services etc. To support such packet-based services, packetization of transport network using Packet Transport Network (PTN) technologies has gradually become a trend in the industry. PTN technologies may be deployed to efficiently transport packet traffic, while maintaining some characteristics of a traditional transport network (e.g. SONET and SDH) such as high reliability, and ease of operation, maintenance and management etc.

A number of PTN technologies have been developed for the transport network. An example is provider backbone bridge (PBB, also known as MAC-in-MAC), which is a layer 2 virtual private network (L2VPN) technology and defined by IEEE802.1ah. PBB allows separation of customer and provider domains by encapsulating a customer's MAC (C-MAC) address with a provider's backbone MAC (B-MAC) address. Other examples include Virtual Private LAN Service (VPLS) and Multiple Protocol Label Switching Transport Profile (MPLS-TP) etc.

### BRIEF DESCRIPTION OF DRAWINGS

By way of non-limiting examples, embodiment(s) of the present disclosure will be described with reference to the following drawings, in which:

FIG. 1 is a schematic diagram of an example PTN in which data transmission is facilitated by a multiple stack device;

FIG. 2 is a flowchart of an example method for data transmission in a PTN;

FIG. 3 is a flowchart of an example implementation of the method in FIG. 2 using a MPLS-TP/PBB dual stack device;

FIG. 4 is a flowchart of an example detailed implementation of the method in FIG. 3 when MPLS-TP protection tunnel 1+1 is used;

FIG. 5 is a flowchart of an example detailed implementation of the method in FIG. 3 when MPLS-TP protection tunnel 1:1 is used;

FIG. 6 is a flowchart of an example implementation of the method in FIG. 2 using a VPLS/PBB dual stack device; and

FIG. 7 is a block diagram of an example structure of a network device capable of acting as a multiple stack device.

### DETAILED DESCRIPTION

A multiple (e.g. dual) stack device may be used to facilitate data transmission between edge devices employing different PTN technologies in a PTN. For example, a VPLS/PBB dual stack device may be used to connect a Backbone Edge Bridge (BEB) device employing PBB with a Provider Edge (PE) device employing VPLS. A conventional VPLS/PBB dual stack device may issue two sets of hardware table entries to facilitate data transmission between the BEB device and PE device. This is because PBB does not use protocol packets for connection establishment, which is instead triggered by data packets.

The VPLS/PBB dual stack device analyses a customer MAC (C-MAC) address in a received packet to decide on how the packet is forwarded. The VPLS/PBB dual stack device generally relies on one set of table entries to trigger the establishment of a connection and to forward a packet with an unknown MAC address (e.g. via broadcasting), and another set to forward a packet with a known MAC address (e.g. via unicasting).

The present disclosure describes data transmission in a PTN that includes a first edge device of a first PTN technology, a second edge device of a second PTN technology and a multiple stack device facilitating data transmission between the first edge device and the second edge device. In one example, after receiving a first packet of the first PTN technology, the multiple stack device identifies a first connection with the first edge device according to information of the first packet. The multiple stack device then identifies a second connection with the second edge device from the first connection based on a relationship between the first connection and second connection. The first packet is then de-encapsulated and re-encapsulated into a second packet of the second PTN technology according to the second connection. The second packet is then forwarded to the second edge device via the second connection.

Using the above example, the multiple stack device is able to identify the second connection from the first connection based on a relationship between them. This allows forwarding of the second packet to the second edge device via the second connection. The above example does not require two sets of hardware table entries, and as such, hardware resource consumption at the multiple stack device is reduced. For example, data transmission may be facilitated between a BEB device employing PBB and a PE device employing VPLS or MPLS-TP. In the case where PBB is used, the above example does not require checking the C-MAC address in a received MAC-in-MAC packet.

Examples will be described with reference to accompanying drawings.

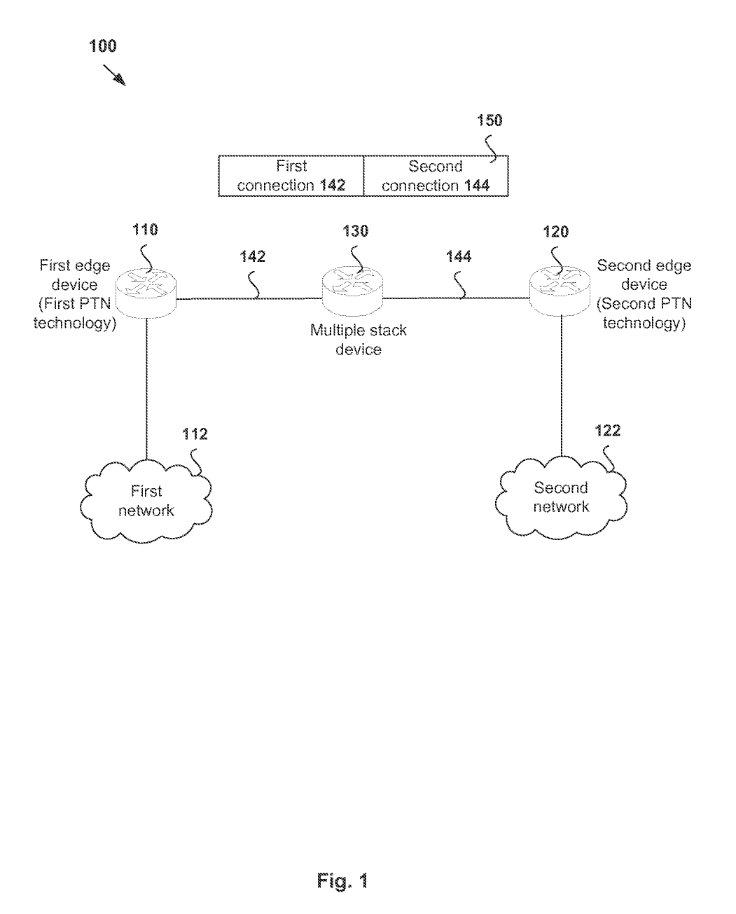

FIG. 1 is a schematic diagram of an example PTN 100 in which a first edge device 110 communicates with a second edge device 120 via a multiple stack device 130. The first edge device 110 employs a first PTN technology and connects with the multiple stack device 130 via a first connection 142. The second edge device 120 employs a second PTN technology and connects with the multiple stack device 130 via a second connection 144. Since a first packet received from the first edge device 110 is of the first PTN technology, the first packet needs to be converted to the second PTN technology before it is forwarded to the second edge device 120.

Throughout this disclosure, the term “multiple stack device” 130 is used to generally refer to any suitable network device with interfaces to receive and transmit packets employing different PTN technologies, such as PBB, VPLS, MPLS-TP and related technologies etc. Although examples have been described with reference to a dual stack device in the present disclosure, it will be appreciated that the multiple stack device is not limited to a dual stack device and depending on the application, may be a n-stack device where n is 2 or more. Further, the term “packet” is used broadly to cover unit of data transmitted over the PTN, and may be used interchangeably with “message” etc. The terms “first” and “second” are used to facilitate easy reference to elements, and are not intended to represent any specific sequence.

Some examples of the edge devices 110/120 and multiple stack device 130 are provided below, but it will be appreciated that other combinations of different PTN technologies may be used in the PTN 100.
In one example, one of the first edge device 110 and second edge device 120 may be a BEB device employing PBB, while the other is a PE device employing MPLS-TP. In this case, the “MPLS-TP/PBB” multiple stack device 130 facilitates data transmission between the first edge device 110 (e.g. BEB device) and second edge device 120 (e.g. PE device). The first network 112 is a PBB network, and the second network 122 a MPLS-TP network.
In another example, one of the first edge device 110 and second edge device 120 may be a BEB device employing PBB, while the other is a PE device employing VPLS. In this case, the “VPLS/PBB” multiple stack device 130 facilitates data transmission between the first edge device 110 (e.g. BEB device) and second edge device 120 (e.g. PE device). The first network 112 is a PBB network, and the second network 122 is a VPLS network.

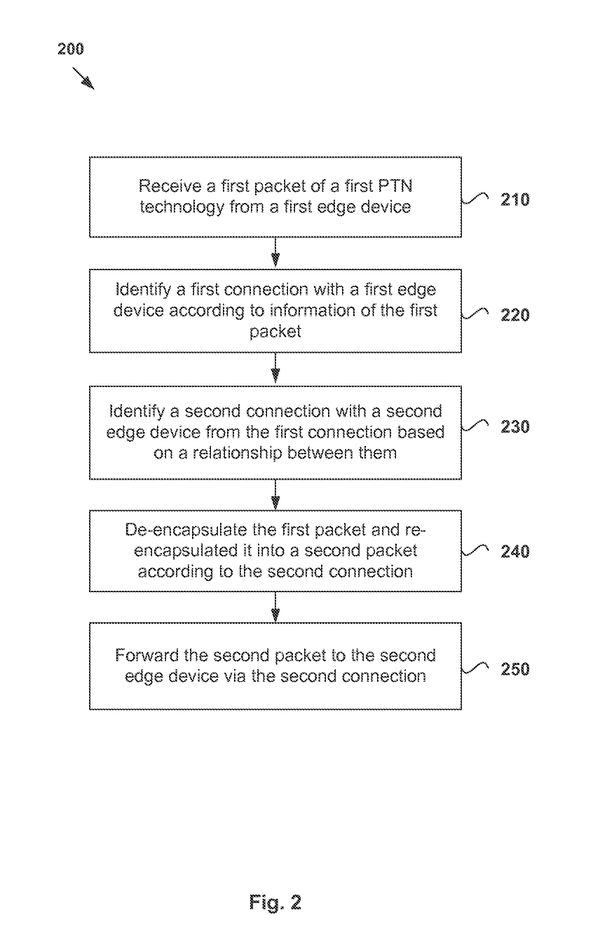

FIG. 2 is a flowchart of an example method 200 for data transmission in the PTN in FIG. 1. The example method 200 may be applied in the multiple stack device 130 connecting the first edge device 110 (e.g. BEB device) and second edge device 120 (e.g. PE device).
At block 210, a first packet of the first PTN technology (e.g. MAC-in-MAC packet) is received by the multiple stack device 130 (e.g. MPLS-TP/PBB or VPLS/PBB) from the first edge device 110 (e.g. BEB device).
At block 220, a first connection 142 between the multiple stack device 130 (e.g. MPLS-TP/PBB or VPLS/PBB) and the first edge device 110 (e.g. BEB device) is identified according to information of the first packet. If the first packet is received from a BEB device, the information may be identification information in a MAC-in-MAC packet, such as B-VLAN (Backbone Virtual Local Area Network), I-SID (Backbone Service Instance Identifier) and B-MAC (Backbone MAC) etc.
At block 230, a second connection 144 with the second edge device 120 (e.g. PE device) is identified from the first connection 142 based on a relationship 150 between the first connection 142 and second connection 144. The relationship 150 may be pre-configured on the multiple stack device 130 using any suitable technique, such as static command line configuration.
At block 240, the multiple stack device 130 de-encapsulates the first packet (e.g. MAC-in-MAC packet), and re-encapsulates the de-encapsulated first packet (e.g. Ethernet message or frame) into a second packet (e.g. MPLS-TP or VPLS packet) according to the second connection 144.
At block 250, the multiple stack device 130 forwards the second packet (e.g. MPLS-TP or VPLS packet) to the second edge device 120 (e.g. PE device) via the second connection 144.

It will be appreciated that the example method 200 may be used for data transmission in the reverse direction, i.e. from a PE device to a BEB device. In this case, the PE device may act as a “first edge device” 110 and the BEB device as a “second edge device” 120 in the above example as follows. In this case, the header information at block 220 may be a label assigned by the PE device for its connection with the multiple stack device 130.
At block 210, a first packet of the first PTN technology (e.g. MPLS-TP or VPLS packet) is received by the multiple stack device 130 (e.g. MPLS-TP/PBB or VPLS/PBB) from the first edge device 110 (e.g. PE device).
At block 220, a first connection 142 between the multiple stack device 130 (e.g. MPLS-TP/PBB or VPLS/PBB) and the first edge device 110 (e.g. PE device) is identified according to information of the first packet (e.g. such a label of a MPLS-TP or VPLS packet).
At block 230, a second connection 144 with the second edge device 120 (e.g. BEB device) is identified from the first connection 142 based on a relationship between the first connection 142 and second connection 144.
At block 240, the multiple stack device 130 de-encapsulates the first packet (e.g. MPLS-TP or VPLS packet), and re-encapsulates the de-encapsulated first packet (e.g. Ethernet message or frame) into a second packet (e.g. MAC-in-MAC packet) according to the second connection 144.
At block 250, the multiple stack device 130 forwards the second packet (e.g. MAC-in-MAC packet) to the second edge device 120 (e.g. BEB device) via the second connection 144.

The relationship 150 between the first connection 142 and second connection 144 may be configured on the multiple stack device 130 prior to receiving the first packet. The configuration allows the multiple stack device 130 to learn about the relationship between the first connection 142 and second connection 144. Any suitable technique may be used for the configuration, such as static command line etc.

In a peer to peer (P2P) network, the relationship (150 in FIG. 1) between the first connection 142 and second connection 144 may be one-to-one. In other words, the first connection 142 identifies the second connection 144 and vice versa. As such, there is also a corresponding relationship between “first” information identifying the first connection (e.g. identification information in a MAC-in-MAC packet or label of a MPLS-TP or VPLS message) and “second” information identifying the second connection (e.g. label in a MPLS-TP or VPLS packet). The relationship between the first and second information also identifies the relationship between the first 142 and second connections 144.

Data Transmission between MPLS-TP and PBB Networks

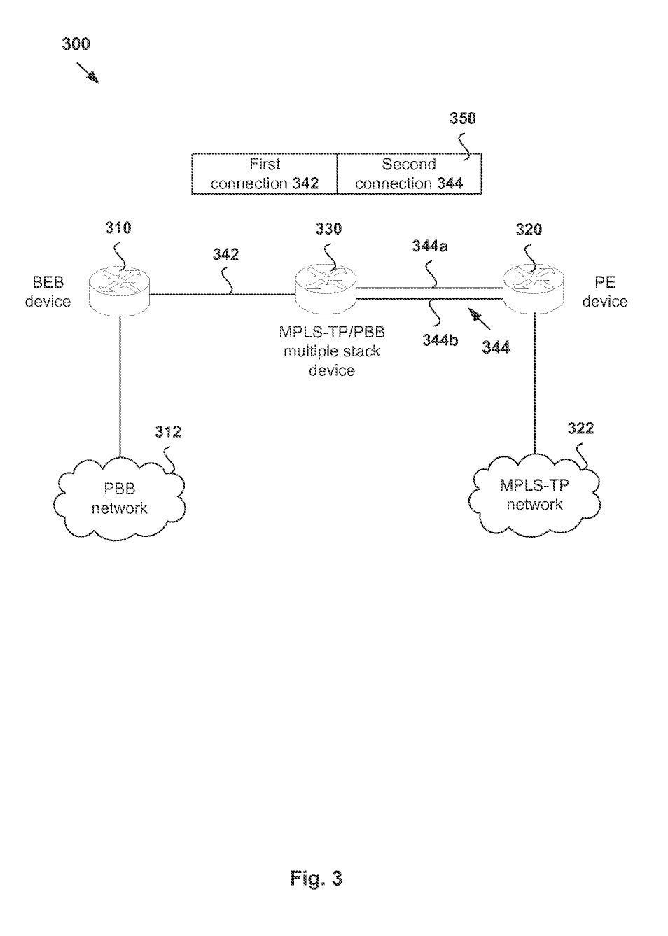

Referring now to FIG. 3, an example PTN 300 where a BEB device 310 is connected to a PE device 320 via an MPLS-TP/PBB dual stack device 330. The MPLS-TP/PBB dual stack device 330 is connected with the PE device 320 via a main tunnel 344a and a standby tunnel 344b. The connection established between the MPLS-TP/PBB dual stack device 330 and the PE device 320 may be MPLS-TP 1+1 protection tunnel or 1:1 protection tunnel. According to MPLS-TP protocol, a label for the main tunnel 344a is different to a label for the standby tunnel 344b.

In one example, the MPLS-TP/PBB dual stack device 330 may be configured using the following static command line:
[MPLS-TP/PBB] pbb out-interface interface ethernet 1/1 i-sid 100 b-vlan 100 b-mac 1-1-1 mpls-tp peer 1.1.1.1 vsi 100.

The static command line configures a relationship between the first connection 342 and second connection 344 on the MPLS-TP/PBB dual stack device 330. The relationship between the first connection 342 and second connection 344 may be one-to-one. In particular, the first connection 342 is between the MPLS/PBB dual stack device 330 and BEB device 310 (with I-SID 100 B-VLAN 100 B-MAC 1-1-1).

The second connection 344 is between the MPLS/PBB dual stack device 330 and PE device 320 within Virtual Switch Instance (VSI) 100. Here, the VSI is a virtual instance of a layer 2 switching service provided by the PE device 320. The PE device 320 establishes a virtual connection with a peer (MPLS-TP/PBB dual stack device) within the same VSI and assigns a unique label to the established connection. The label may include a main tunnel label (e.g. Label 1) and/or a standby tunnel label (e.g. Label 2).

The static command line configures that the MPLS/PBB dual stack device 330 is connected with the PBB network 312 via outgoing interface ‘ethernet 1/1’, and connected with the MPLS-TP network 322 via the PE device 320 with network address ‘1.1.1.1’.

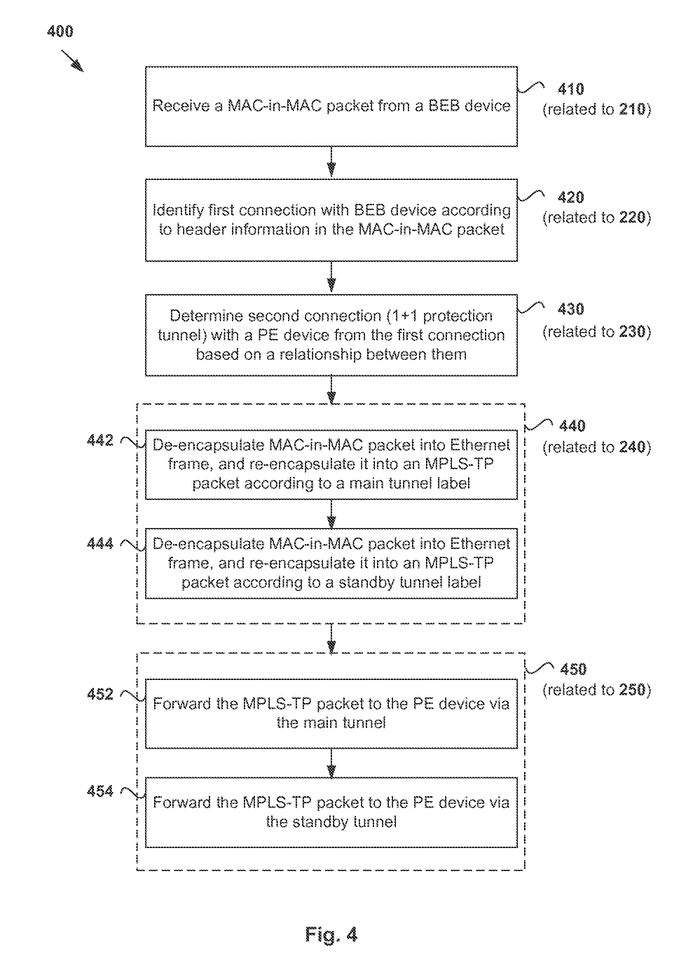

FIG. 4 shows an example of data transmission for the network in FIG. 3 according to FIG. 2 in the case where MPLS-TP 1+1 protection tunnel is used, i.e. MPLS-TP packets are forwarded via both main tunnel and standby tunnel. In one example, the example in FIG. 4 may be used for data transmission from a BEB device 310 to a PE device 320 (e.g. with network address ‘1.1.1.1’).
At block 410 (related to 210 in FIG. 2), the MPLS-TP/PBB dual stack device 330 receives a MAC-in-MAC packet from a BEB device 310 (“first edge device”).
At block 420 (related to 220 in FIG. 2), the MPLS-TP/PBB dual stack device 330 identifies a first connection 342 with the BEB device 310 according to identification information of the MAC-in-MAC packet (e.g. B-VLAN 100, I-SID 100 and B-MAC 1-1-1).
At block 430 (related to 230 in FIG. 2), the MPLS-TP/PBB dual stack device 330 identifies a second connection 344 (i.e. MPLS-TP 1+1 protection tunnel) with the PE device 320 from the first connection 342 based on a relationship 350 between the first connection 342 and the MPLS-TP 1+1 protection tunnel 344 is shown in FIG. 3.
At block 440 (related to 240 in FIG. 2), the MPLS-TP/PBB dual stack device 330 de-encapsulates the MAC-in-MAC packet into an Ethernet frame, and re-encapsulates the Ethernet frame into MPLS-TP packets based on a main tunnel label (see block 442) and a standby tunnel label (see block 444) assigned by the PE device to the second connection 344 respectively.
At block 450 (related to 250 in FIG. 2), the MPLS-TP/PBB dual stack device 330 forwards the MPLS-TP packet to the PE device 310, i.e. one copy via the main tunnel (see block 452) and another via the standby tunnel (see block 454) from respective outgoing ports.

In the above, information such as B-VLAN 100, I-SID 100 and B-MAC 1-1-1 in the received MAC-in-MAC packet allows the MPLS/PBB dual stack device 330 to identify the first connection 342. This in turns allows the MPLS/PBB dual stack device 330 to identify the second connection 344 based on the pre-configured relationship between the first 342 and second 344 connection.

Since MPLS-TP 1+1 protection tunnel is used, the PE device 320 will receive both MPLS-TP packets via the main tunnel and standby tunnel respectively, but will only forward one of them to the MPLS-TP network 322. Since different labels are assigned for the main tunnel 344a and standby tunnel 344b, the PE device 320 is able to identify the tunnel through which an MPLS-TP is received. For example, the MPLS-TP received via the main tunnel 344a is forwarded while the one received via the standby tunnel 344b is discarded. After de-encapsulating the MPLS-TP packet received via the main tunnel 344a, the PE device 320 searches for a destination MAC address in the Ethernet frame in a MAC table. Then, the Ethernet frame is forwarded to an outgoing port corresponding to the destination MAC address to the MPLS-TP network 322.

FIG. 4 may also be applied to data transmission from the PE device 320 to the BEB device 310 via the MPLS-TP/PBB dual stack device 330. In this case, after receiving MPLS-TP packets from both the main tunnel 344a and standby tunnel 344b, the MPLS-TP/PBB dual stack device 330 discards one of the packets, e.g. the packet received via the standby tunnel 344b. Based on a label of the main tunnel 344a (e.g. label 1), the MPLS-TP/PBB dual stack device 330 identifies the second connection 344 with the PE device 320, and then the corresponding first connection 342 with the BEB device 310 (i.e. connection corresponding with B-VLAN 100, I-SID 100 and B-MAC 1-1-1).

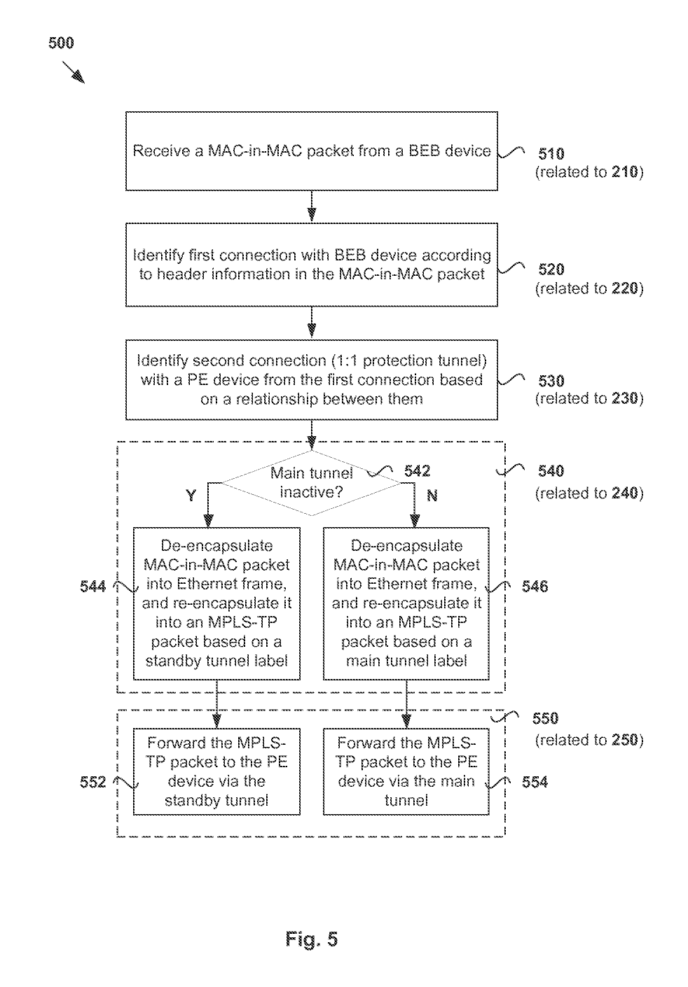

FIG. 5 shows an example of data transmission according to FIG. 2 in the case where MPLS-TP 3:1 protection tunnel is used, i.e. an MPLS-TP packet is forwarded via a standby tunnel only when the main tunnel is inactive.
At block 510 (related to 210 in FIG. 2), the MPLS-TP/PBB dual stack device 330 receives a MAC-in-MAC packet from a BEB device 310.
At block 520 (related to 220 in FIG. 2), the MPLS-TP/PBB dual stack device 330 identifies a first connection 342 with the BEB device according to identification information in the MAC-in-MAC packet (e.g. B-VLAN 100, I-SID 100 and B-MAC 1-1-1).
At block 530 (related to 230 in FIG. 2), the MPLS-TP/PBB dual stack device 330 determines a second connection 344 (MPLS-TP 1:1 protection tunnel) with the PE device 320 according to the first connection 342. The relationship 350 between the first connection and the MPLS-TP 1:1 protection tunnel is shown in FIG. 3.
At block 540 (related to 240 in FIG. 2), the MPLS-TP/PBB dual stack device 330 determines whether the main tunnel 344a is inactive; see block 542.
If the main tunnel is inactive (block 544), the MPLS-TP/PBB dual stack device 330 de-encapsulates the MAC-in-MAC packet into an Ethernet frame, and re-encapsulates the Ethernet frame into an MPLS-TP packet according to a standby tunnel label 344b assigned by the PE device to the second connection 344.
Otherwise (main tunnel 344a is active, block 546), the MPLS-TP/PBB dual stack device 330 de-encapsulates the MAC-in-MAC packet into an Ethernet frame, and re-encapsulates the Ethernet frame into an MPLS-TP packet according to a main tunnel label 344a assigned by the PE device to the second connection 344.
At block 550 (related to FIG. 2), the MPLS-TP/PBB dual stack device 330 either forwards the MPLS-TP packet to the PE device via the main tunnel 344a or the standby tunnel 344b.

Unlike the case of 1+1 protection tunnel in FIG. 4, the PE device 320 only receives one MPLS-TP packet from the MPLS-TP/PBB dual stack device 330 via the main tunnel 344a (or the standby tunnel 344b if the main tunnel is inactive).

At the PE device 320, after de-encapsulating the received MPLS-TP packet, the PE device 320 searches the MAC table according to a destination MAC address in the Ethernet frame to determine the corresponding outgoing port through which the Ethernet packet is sent to the MPLS-TP network 322.

Data Transmission between VPLS and PBB Networks

In another example, the multiple stack device 130 in FIG. 1 may be a VPLS/PBB dual stack device that facilitates data transmission between a PE device of VPLS technology and a BEB device of PBB technology and.

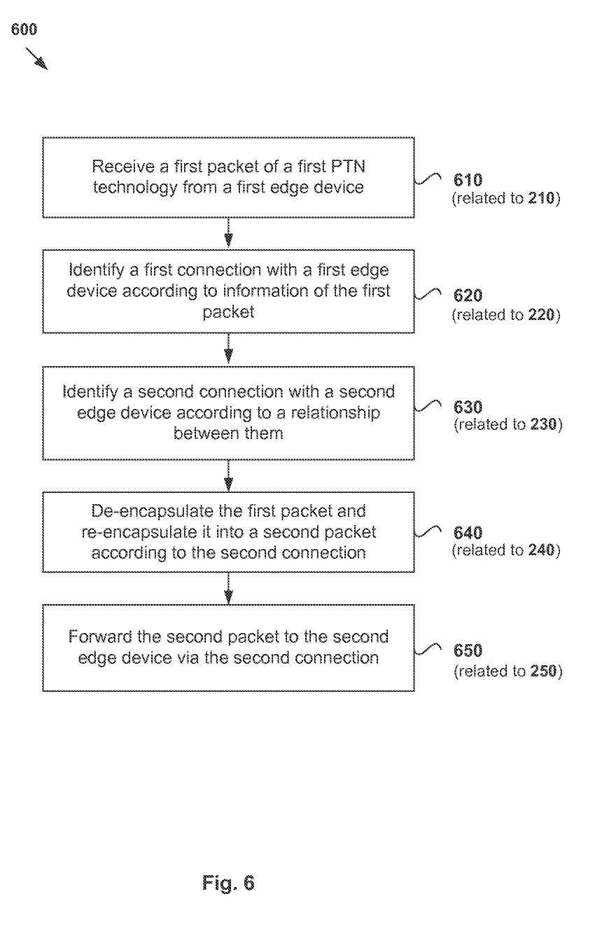

Referring now to FIG. 6, the data transmission may include the following when the BEB device (first edge device 110) transmits data to the PE device (second edge device 120).
At block 610 (related to 210 in FIG. 2), a MAC-in-MAC packet is received by the VPLS/PBB dual stack device 130 from the PE device.
At block 620 (related to 220 in FIG. 2), a first connection 142 between the VPLS/PBB dual stack device 130 and the PE device is identified according to information of the MAC-in-MAC packet. In this case, the information may be identification information of the received MAC-in-MAC packet, such as B-VLAN, I-SID and B-MAC etc.
At block 630 (related to 230 in FIG. 2), a second connection 144 with the BEB device is identified from the first connection 142 based on a relationship between the first connection 142 and second connection 144. The relationship may be configured on the VPLS/PBB dual stack device 130 prior to receiving the MAC-in-MAC packet.
At block 640 (related to 240 in FIG. 2), the multiple stack device 130 de-encapsulates the MAC-in-MAC packet into an Ethernet message or frame, and re-encapsulates the Ethernet message or frame into a VPLS packet according to the second connection 144.
At block 650 (related to 250 in FIG. 2), the multiple stack device 130 forwards the VPLS packet to the PE device via the second connection 144 between the PE device and VPLS/PBB dual stack device.

The example in FIG. 6 may be applied to data transmission in the reverse direction, i.e. from the PE device (first edge device 110 in this case) transmits data to the BEB device (second edge device 120).
At block 610, a VPLS packet is received by the VPLS/PBB dual stack device 130 from the PE device.
At block 620, a first connection 142 between the VPLS/PBB dual stack device 130 and the PE device is identified according to information of the VPLS packet. In this case, the information may be a label of the VPLS packet received from the PE device.
At block 630, a second connection 144 with the BEB device is identified from the first connection 142 based on a relationship between the first connection 142 and second connection 144.
At block 640, the multiple stack device 130 de-encapsulates the VPLS packet first packet into an Ethernet message or frame, and re-encapsulates the Ethernet message or frame into a MAC-in-MAC packet according to the second connection 144.
At block 650, the multiple stack device 130 forwards the MAC-in-MAC packet to the BEB device via the second connection 144 between the BEB device and VPLS/PBB dual stack device.

Network Device 700

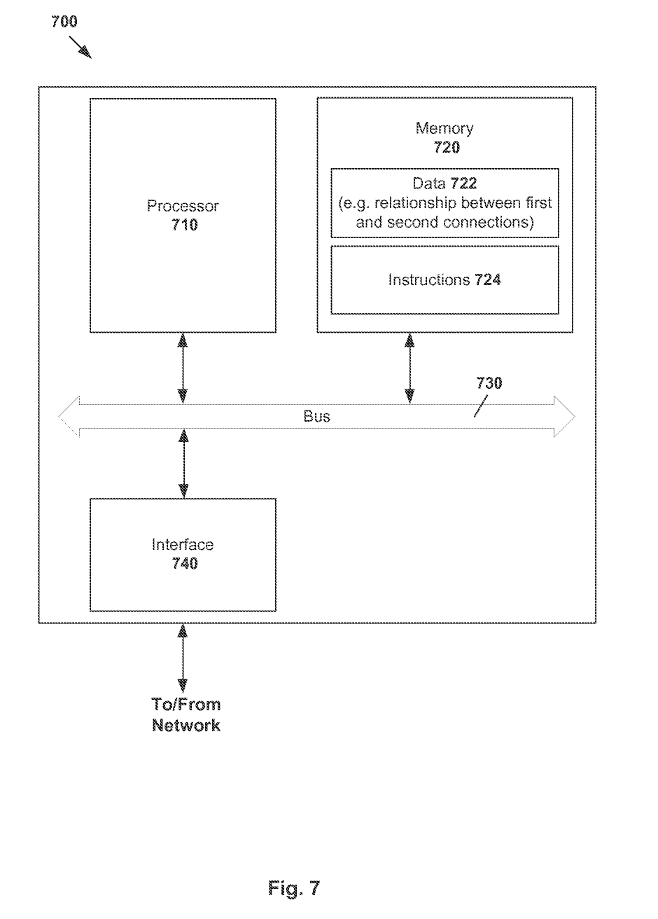

The above examples can be implemented by hardware, software or firmware or a combination thereof. Referring to FIG. 7, an example network device 700 capable of acting as a multiple stack device 130/330 for facilitating data transmission between an first edge device of a first PTN technology and a second edge device of a second PTN technology in PTN. The network device 700 may be a switch etc.

The example network device 700 includes a processor 710, a memory 720 and a network interface device 740 that communicate with each other via bus 730. The processor 710 is to perform processes described herein with reference to FIG. 1 to FIG. 6. In one example, the processor 710 is to perform the following:
Receive a first packet of the first PTN technology from the first edge device.
Identify a first connection with the first edge device according to information of the first packet. For example, the information may be identification information in a MAC-in-MAC packet or a label of a MPLS-TP packet or VPLS packet.
Identify a second connection with the second edge device from the first connection based on a relationship between the first connection and the second connection. For example, the relationship may be configured on the device 700 prior to receiving the first packet.
De-encapsulate the first packet and re-encapsulate the de-encapsulated first packet into a second packet of the second PTN technology according to the second connection.
Forward the second packet to the second edge device via the second connection.

The memory 720 may store any necessary data 722 and machine-readable instructions 724 to perform any of the processes described in the present disclosure. The data 722 may include the relationship (see 150 in FIG. 1 or 350 in FIG. 3) between the first connection and second connection, and information identifying the first and second connection (e.g. B-VLAN, I-SID and B-MAC or a MPLS-TP or VPLS label etc).

The memory 720 may store machine-readable instructions 724 executable by the processor 710 and to cause the processor 710 to perform processes described herein. In one example, the instructions 724 (not shown in FIG. 7 for simplicity) may include:
Receiving instruction to receive a first packet of the first PTN technology from the first edge device.
Processing instruction to identify a first connection with the first edge device according to information of the first packet.
The processing instruction is further to identify a second connection with the second edge device from the first connection based on a relationship between the first connection and the second connection.
The processing instruction is further to de-encapsulate the first packet and re-encapsulate the de-encapsulated first packet into a second packet of the second PTN technology according to the second connection.
Forwarding instruction to forward the second packet to the second edge device via the second connection.

The methods, processes and functional units described herein may be implemented by hardware (including hardware logic circuitry), software or firmware or a combination thereof. The term ‘processor’ is to be interpreted broadly to include a processing unit, ASIC, logic unit, or programmable gate array etc. The processes, methods and functional units may all be performed by the one or more processors 710; reference in this disclosure or the claims to a ‘processor’ should thus be interpreted to mean ‘one or more processors’.

Although one network interface device 740 is shown in FIG. 7, processes performed by the network interface device 740 may be split among multiple network interface devices (not shown for simplicity). As such, reference in this disclosure to a ‘network interface device’ should be interpreted to mean ‘one or more network interface devices”.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A data transmission method for use in a packet transport network (PTN), the PTN comprising a first edge device of a first PTN technology, a second edge device of a second PTN technology, and a multiple stack device facilitating data transmission between the first edge device and second edge device, the method comprising the multiple stack device:
receiving a first packet of the first PTN technology from the first edge device;
identifying a first connection with the first edge device according to information of the first packet;
identifying a second connection with the second edge device from the first connection based on a relationship between the first connection and the second connection;
de-encapsulating the first packet and re-encapsulating the de-encapsulated first packet into a second packet of the second PTN technology according to the second connection; and
forwarding the second packet to the second edge device via the second connection.

2. The method of claim 1, further comprising: prior to receiving the first packet, configuring the relationship between the first connection and second connection on the multiple stack device.

3. The method of claim 1, wherein:
the first packet is a MAC-in-MAC packet of Provider Backbone Bridge (PBB) technology received from a Backbone Edge Bridge (BEB) device; and
information of the first packet from which the first connection is identified is identification information that includes backbone virtual local area network (B-VLAN), Backbone Service Instance Identifier (I-SID) and Backbone Media Access Control (B-MAC).

4. The method of claim 1, wherein:
the first packet is a Multi-Protocol Label Switching-Transport Profile (MPLS-TP) packet of MPLS-TP technology or a Virtual Private Local Area Network Service (VPLS) packet of VPLS technology received a Provider Edge (PE) device; and
information in the first packet from which the first connection is identified is a label of the first packet.

5. The method of claim 1, wherein:
the second packet is an MPLS-TP packet and the second connection is an MPLS-TP 1+1 protection tunnel associated with a main tunnel and a standby tunnel; and
re-encapsulating the de-encapsulated first packet into the MPLS-TP packet is based on a main tunnel label and a standby tunnel label, and the MPLS-TP packet is forwarded to the PE device via both the main tunnel and the standby tunnel.

6. The method of claim 1, wherein:
the second packet is an MPLS-TP packet and the second connection is an MPLS-TP 1:1 protection tunnel associated with a main tunnel and a standby tunnel; and
re-encapsulating the de-encapsulated first packet into the MPLS-TP packet further comprises:
determining whether the main tunnel is inactive;
if the main tunnel is inactive, re-encapsulating into the MPLS-TP packet is based on a standby tunnel label, and forwarding the MPLS-TP packet via the standby tunnel;
otherwise, re-encapsulating into the MPLS-TP packet based on a main tunnel label and forwarding the MPLS-TP packet via the main tunnel.

7. The method of claim 1, wherein:
one of the first device and the second device is a BEB device of Provider Backbone Bridge (PBB) technology, and the other is a PE device of MPLS-TP technology; and
the multiple stack device is an MPLS-TP/PBB dual stack device for de-encapsulating a MAC-in-MAC packet into an Ethernet packet and re-encapsulating the Ethernet packet into a MPLS-TP packet, and vice versa.

8. The method of claim 1, wherein:
one of the first device and the second device is a BEB device of Provider Backbone Bridge (PBB) technology, and the other is a PE device of VPLS technology; and
the multiple stack device is an VPLS/PBB dual stack device for de-encapsulating a MAC-in-MAC packet into an Ethernet packet and re-encapsulating the Ethernet packet into a VPLS packet, and vice versa.

9. A device capable of acting as a multiple stack device for facilitating data transmission between an first edge device of a first packet transport network (PTN) technology and a second edge device of a second PTN technology in a PTN, the multiple stack device comprising a processor to:
receive a first packet of the first PTN technology from the first edge device;
identify a first connection with the first edge device according to information of the first packet;
identify a second connection with the second edge device from the first connection based on a relationship between the first connection and the second connection;
de-encapsulate the first packet and re-encapsulate the de-encapsulated first packet into a second packet of the second PTN technology according to the second connection; and
forward the second packet to the second edge device via the second connection.

10. The device of claim 9, wherein the processor is further to, prior to receiving the first packet, configure the relationship between the first connection and second connection on the multiple stack device.

11. The device of claim 9, wherein the first packet is one of the following:
a MAC-in-MAC packet of Provider Backbone Bridge (PBB) technology received from a Backbone Edge Bridge (BEB) device, in which case information of the first packet from which the first connection is identified is identification information that includes backbone virtual local area network (B-VLAN), Backbone Service Instance Identifier (I-SID) and Backbone Media Access Control (B-MAC); and
a Multi-Protocol Label Switching-Transport Profile (MPLS-TP) packet of MPLS-TP technology or a Virtual Private Local Area Network Service (VPLS) packet of VPLS technology received a Provider Edge (PE) device, in which case information in the first packet from which the first connection is identified is a label of the first packet.

12. The device of claim 9, wherein:
the second packet is an MPLS-TP packet and the second connection is an MPLS-TP 1+1 protection tunnel associated with a main tunnel and a standby tunnel; and
the processor is to re-encapsulate the de-encapsulated first packet into the MPLS-TP packet based on a main tunnel label and a standby tunnel label, and forward the MPLS-TP packet to the PE device via both the main tunnel and the standby tunnel.

13. The device of claim 9, wherein:
the second packet is an MPLS-TP packet and the second connection is an MPLS-TP 1:1 protection tunnel associated with a main tunnel and a standby tunnel; and
when re-encapsulating the de-encapsulated first packet into the MPLS-TP packet, the processor is further to:
determine whether the main tunnel is inactive;
if the main tunnel is inactive, re-encapsulate into the MPLS-TP packet is based on a standby tunnel label, and forward the MPLS-TP packet via the standby tunnel;
otherwise, re-encapsulate into the MPLS-TP packet based on a main tunnel label and forward the MPLS-TP packet via the main tunnel.

14. The device of claim 9, wherein:
one of the first edge device and the second edge device is a BEB device of Provider Backbone Bridge (PBB) technology, and the other is a PE device of MPLS-TP technology; and
the multiple stack device is an MPLS-TP/PBB dual stack device and the processor is to de-encapsulate a MAC-in-MAC packet into an Ethernet frame and re-encapsulate the Ethernet frame into a MPLS-TP packet, and vice versa.

15. The device of claim 9, wherein:
one of the first device and the second device is a BEB device of Provider Backbone Bridge (PBB) technology, and the other is a PE device of VPLS technology; and
the multiple stack device is an VPLS/PBB dual stack device and the processor is to de-encapsulate a MAC-in-MAC packet into an Ethernet frame and re-encapsulate the Ethernet frame into a VPLS packet, and vice versa.
